(19) United States
(12) Patent Application Publication
(10) Pub. No.: US 2017/0078797 A1
(43) Pub. Date: Mar. 16, 2017

(54) Terminal and System Capable of Reducing Noise Generated in Process of Plugging or Unplugging Earphone

(71) Applicant: Huawei Technologies Co., Ltd., Shenzhen (CN)

(72) Inventors: Wei SU, Shenzhen (CN); Huogen KUANG, Shanghai (CN)

(21) Appl. No.: 15/311,334

(22) PCT Filed: Jul. 4, 2014
(86) PCT No.: PCT/CN2014/081661

§ 371 Date: Nov. 15, 2016

(30) Foreign Application Priority Data
Jun. 30, 2014 (CN) PCT/CN2014/081229

(51) Int. Cl. H04R 5/04; H04R 5/033; H04R 29/00

(52) U.S. Cl. CPC H04R 5/04; H04R 29/001; H04R 5/033

(57) ABSTRACT

A terminal and a system capable of reducing noise generated in a process of plugging or unplugging an earphone. The terminal includes: an earphone socket, a switch circuit, an earphone power supply circuit, and a bleeder circuit, where a first pin of the earphone socket is connected to a control pin of the switch circuit, a second pin of the earphone socket is connected to an input terminal of the switch circuit, a first output terminal of the switch circuit is connected to the earphone power supply circuit, and a second output terminal of the switch circuit is connected to the bleeder circuit.

### CROSS-REFERENCE TO RELATED APPLICATIONS

This application is a national stage application of international patent application number PCT/CN2014/081661 filed on Jul. 4, 2014, which claims priority to international patent application number PCT/CN2014/081229 filed on Jun. 30, 2014, which are incorporated by reference.

### TECHNICAL FIELD

Embodiments of the present disclosure relate to communications technologies, and in particular, to a terminal and a system capable of reducing noise generated in a process of plugging or unplugging an earphone.

### BACKGROUND

With the development of electronic technologies, electronic products feature increasingly powerful functions and become increasingly popularized. As the electronic products are used more frequently to play a video file and an audio file, earphones are also used more frequently. However, noise may come from an audio-left channel or an audio-right channel of an earphone when the earphone is being plugged into or unplugged from an earphone socket.

By using an example in which the earphone is plugged into or unplugged from the earphone socket to a position shown in FIG. 1, the following describes a reason why noise is generated when the earphone is being plugged into or unplugged from the earphone socket. As shown in FIG. 1, a pin 2 of the earphone socket is in contact with a section G of the earphone, and a pin 3 of the earphone socket is in contact with a section R of the earphone. Therefore, a voltage on a microphone bias voltage MIC_BIAS forms a loop from the audio-right channel of the earphone, and then noise comes from the audio-right channel of the earphone.

In particular, an active noise reduction earphone that is powered by using a 3.5 millimeters (mm) earphone jack on a mobile phone board side generates louder noise when the earphone is being plugged into or unplugged from the earphone socket. Because the active noise reduction earphone needs to be powered by using the pin 2 of the earphone socket, a higher supply voltage causes louder noise to be generated when the earphone is being plugged into or unplugged from the earphone socket. Frequent noise impairs hearing of a user; therefore, how to reduce noise generated in a process of plugging or unplugging an earphone becomes a problem to be resolved urgently.

### SUMMARY

Embodiments of the present disclosure provide a terminal and a system capable of reducing noise generated in a process of plugging or unplugging an earphone, to reduce noise generated in a process of plugging or unplugging an earphone.

According to a first aspect, an embodiment of the present disclosure provides a terminal capable of reducing noise generated in a process of plugging or unplugging an earphone, including: an earphone socket, a switch circuit, an earphone power supply circuit, and a bleeder circuit, where the earphone socket includes a first pin and a second pin, the switch circuit includes a control pin, an input terminal, a first output terminal, and a second output terminal, the first pin of the earphone socket is connected to the control pin of the switch circuit, the second pin of the earphone socket is connected to the input terminal of the switch circuit, the first output terminal of the switch circuit is connected to the earphone power supply circuit, and the second output terminal of the switch circuit is connected to the bleeder circuit; the bleeder circuit is configured to reduce a difference between voltages passing through an audio-left channel or an audio-right channel of the earphone, the terminal determines, by detecting a voltage of the first pin, whether the earphone is plugged or unplugged, and the terminal supplies power to the earphone by using the second pin; where when an input voltage of the control pin of the switch circuit is lower than a first preset voltage value, the control pin of the switch circuit controls the input terminal of the switch circuit to be connected to the first output terminal of the switch circuit; or when an input voltage of the control pin of the switch circuit is higher than a second preset voltage value, the control pin of the switch circuit controls the input terminal of the switch circuit to be connected to the second output terminal of the switch circuit.

With reference to the first aspect, in a first possible implementation manner of the first aspect, the terminal further includes a voltage adjustment unit, where that the first pin of the earphone socket is connected to the control pin of the switch circuit is specifically: the first pin of the earphone socket is connected to one terminal of the voltage adjustment unit, and another terminal of the voltage adjustment unit is connected to the control pin of the switch circuit; and the voltage adjustment unit is configured to: adjust the input voltage of the control pin of the switch circuit to be lower than the first preset voltage value according to the voltage of the first pin of the earphone socket; or adjust the input voltage of the control pin of the switch circuit to be higher than the second preset voltage value according to the voltage of the first pin of the earphone socket.

With reference to the first possible implementation manner of the first aspect, in a second possible implementation manner of the first aspect, the voltage adjustment unit is specifically a voltage comparator, and the voltage comparator is configured to: adjust the input voltage of the control pin of the switch circuit to be lower than the first preset voltage value according to the voltage of the first pin of the earphone socket and a reference voltage; or adjust the input voltage of the control pin of the switch circuit to be higher than the second preset voltage value according to the voltage of the first pin of the earphone socket and a reference voltage.

With reference to the first aspect, in a third possible implementation manner of the first aspect, the terminal further includes a central processing unit (CPU), where that the first pin of the earphone socket is connected to the control pin of the switch circuit is specifically: the first pin of the earphone socket is electrically connected to the CPU, and the CPU is electrically connected to the control pin of the switch circuit; and the CPU is configured to: adjust the input voltage of the control pin of the switch circuit to be lower than the first preset voltage value according to the voltage of the first pin of the earphone socket; or adjust the input voltage of the control pin of the switch circuit to be higher than the second preset voltage value according to the voltage of the first pin of the earphone socket.

With reference to the first aspect or any one of the foregoing possible implementation manners of the first aspect, in a fourth possible implementation manner of the first aspect, the bleeder circuit includes a pull-down resistor, where one terminal of the pull-down resistor is connected to the second output terminal of the switch circuit; and the other terminal of the pull-down resistor is connected to a ground of the terminal, or the other terminal of the pull-down resistor is connected to the earphone power supply circuit.

With reference to the fourth possible implementation manner of the first aspect, in a fifth possible implementation manner of the first aspect, when the other terminal of the pull-down resistor is connected to the ground of the terminal, a resistance of the pull-down resistor is less than or equal to 1 kiloohm (kΩ).

With reference to the fourth possible implementation manner of the first aspect, in a sixth possible implementation manner of the first aspect, when the other terminal of the pull-down resistor is connected to the earphone power supply circuit, a resistance of the pull-down resistor is greater than or equal to 5 kΩ.

With reference to the first aspect or any one of the foregoing possible implementation manners of the first aspect, in a seventh possible implementation manner of the first aspect, the earphone socket needs to satisfy the following conditions: after the earphone is entirely plugged into the earphone socket, a contact of the second pin of the earphone socket comes into reliable contact with the earphone; and when the earphone is being plugged into the earphone socket, the contact of the second pin of the earphone socket is not in contact with a conductive section of the earphone at a moment when the first pin of the earphone socket comes into contact with the earphone.

According to a second aspect, an embodiment of the present disclosure provides a terminal capable of reducing noise generated in a process of plugging or unplugging an earphone, including: an earphone socket, a switch circuit, an earphone power supply circuit, and a bleeder circuit, where the earphone socket includes a first pin and a second pin, the switch circuit includes a control pin, an input terminal, a first output terminal, and a second output terminal, the first pin of the earphone socket is connected to the control pin of the switch circuit, the second pin of the earphone socket is connected to the input terminal of the switch circuit, the first output terminal of the switch circuit is connected to the earphone power supply circuit, and the second output terminal of the switch circuit is connected to the bleeder circuit; the bleeder circuit is configured to reduce a difference between voltages passing through an audio-left channel or an audio-right channel of the earphone, the terminal determines, by detecting a voltage of the first pin, whether the earphone is plugged or unplugged, and the terminal supplies power to the earphone by using the second pin; where when an input voltage of the control pin of the switch circuit is lower than a first preset voltage value, the control pin of the switch circuit controls the input terminal of the switch circuit to be connected to the first output terminal of the switch circuit; or when an input voltage of the control pin of the switch circuit is higher than a second preset voltage value, the control pin of the switch circuit controls the input terminal of the switch circuit to be connected to the second output terminal of the switch circuit.

With reference to the second aspect, in a first possible implementation manner of the second aspect, the terminal further includes a voltage adjustment unit, where that the first pin of the earphone socket is connected to the control pin of the switch circuit is specifically: the first pin of the earphone socket is connected to one terminal of the voltage adjustment unit, and another terminal of the voltage adjustment unit is connected to the control pin of the switch circuit, and the voltage adjustment unit is configured to: adjust the input voltage of the control pin of the switch circuit to be lower than the first preset voltage value according to the voltage of the first pin of the earphone socket; or adjust the input voltage of the control pin of the switch circuit to be higher than the second preset voltage value according to the voltage of the first pin of the earphone socket.

With reference to the second possible implementation manner of the second aspect, in a second possible implementation manner of the second aspect, the voltage adjustment unit is specifically a voltage comparator, and the voltage comparator is configured to: adjust the input voltage of the control pin of the switch circuit to be lower than the first preset voltage value according to the voltage of the first pin of the earphone socket and a reference voltage; or adjust the input voltage of the control pin of the switch circuit to be higher than the second preset voltage value according to the voltage of the first pin of the earphone socket and a reference voltage.

With reference to the second aspect, in a third possible implementation manner of the second aspect, the terminal further includes a CPU, where that the first pin of the earphone socket is connected to the control pin of the switch circuit is specifically: the first pin of the earphone socket is electrically connected to the CPU, and the CPU is electrically connected to the control pin of the switch circuit; and the CPU is configured to: adjust the input voltage of the control pin of the switch circuit to be lower than the first preset voltage value according to the voltage of the first pin of the earphone socket; or adjust the input voltage of the control pin of the switch circuit to be higher than the second preset voltage value according to the voltage of the first pin of the earphone socket.

With reference to the second aspect or any one of the foregoing possible implementation manners of the second aspect, in a fourth possible implementation manner of the second aspect, the bleeder circuit includes a pull-down resistor, where one terminal of the pull-down resistor is connected to the second output terminal of the switch circuit; and the other terminal of the pull-down resistor is connected to a ground of the terminal, or the other terminal of the pull-down resistor is connected to the earphone power supply circuit.

With reference to the fourth possible implementation manner of the second aspect, in a fifth possible implementation manner of the second aspect, when the other terminal of the pull-down resistor is connected to the ground of the terminal, a resistance of the pull-down resistor is less than or equal to 1 kΩ.

With reference to the fourth possible implementation manner of the second aspect, in a sixth possible implementation manner of the second aspect, when the other terminal of the pull-down resistor is connected to the earphone power supply circuit, a resistance of the pull-down resistor is greater than or equal to 5 kΩ.

With reference to the second aspect or any one of the foregoing possible implementation manners of the second aspect, in a seventh possible implementation manner of the second aspect, the earphone socket needs to satisfy the following conditions: after the earphone is entirely plugged into the earphone socket, a contact of the second pin of the earphone socket comes into reliable contact with the earphone; and when the earphone is being plugged into the earphone socket, the contact of the second pin of the earphone socket is not in contact with a conductive section of the earphone at a moment when the first pin of the earphone socket comes into contact with the earphone.

According to a third aspect, an embodiment of the present disclosure further provides a system capable of reducing noise generated in a process of plugging or unplugging an earphone, including: the terminal and the earphone according to the first aspect or any one of the implementation manners of the first aspect; or the terminal and the earphone according to the second aspect or any one of the implementation manners of the second aspect.

With reference to the third aspect, in a first possible implementation manner of the third aspect, when a line order of the earphone is L, R, G, and M, a length of the section G of the earphone is W mm; or when a line order of the earphone is L, R, M, and G, a length of the section M of the earphone is W mm; and setting of the earphone needs to satisfy the following conditions: after the earphone is entirely plugged into the earphone socket, a contact of the second pin of the earphone socket comes into reliable contact with the earphone; and when the earphone is being plugged into the earphone socket, the contact of the second pin of the earphone socket is not in contact with a conductive section of the earphone at a moment when the first pin of the earphone socket comes into contact with the earphone.

According to the terminal and the system capable of reducing noise generated in a process of plugging or unplugging an earphone provided in the embodiments of the present disclosure, a switch circuit is added into the terminal, and when an input voltage of a control pin of the switch circuit is a high level or a low level (for an earphone type used with the terminal, either of a high level and a low level is selected), an input terminal of the switch circuit is connected to a second output terminal of the switch circuit, that is, a connection between an earphone power supply circuit and a second pin of an earphone socket is disconnected. Therefore, a voltage on the earphone power supply circuit does not form a loop on an audio-left channel or an audio-right channel of the earphone, and no noise comes from the audio-left channel or the audio-right channel of the earphone, so that noise generated when the earphone is being plugged into or unplugged from the earphone socket is effectively reduced.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show some embodiments of the present disclosure, and persons of ordinary skill in the art may still derive other drawings from these accompanying drawings without creative efforts.

FIG. 1 is a schematic structural diagram of a terminal some approaches;

FIG. 2 is a schematic structural diagram of a terminal according to an embodiment of the present disclosure;

FIG. 3 is a schematic structural diagram of a terminal according to another embodiment of the present disclosure;

FIG. 4 is a schematic structural diagram of a bleeder circuit and a switch circuit according to an embodiment of the present disclosure;

FIG. 5 is a schematic structural diagram of a bleeder circuit and a switch circuit according to another embodiment of the present disclosure;

FIG. 6 is a structural diagram of a system according to an embodiment of the present disclosure;

FIG. 7 is a schematic structural diagram of a standard earphone in some approaches; and

FIG. 8 is a schematic structural diagram of an improved earphone according to an embodiment of the present disclosure.

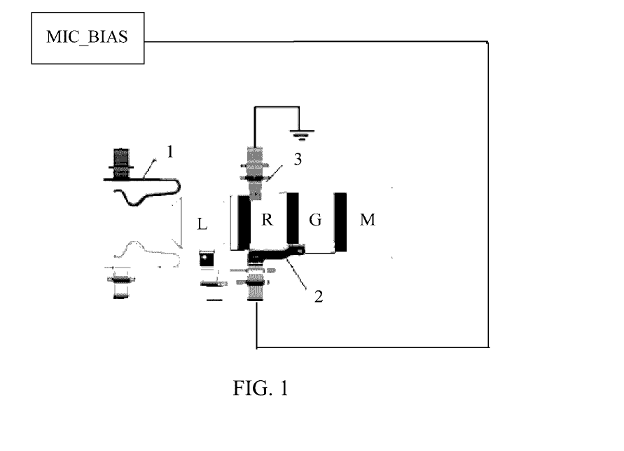

### DESCRIPTION OF EMBODIMENTS

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. Apparently, the described embodiments are a part rather than all of the embodiments of the present disclosure. All other embodiments obtained by persons of ordinary skill in the art based on the embodiments of the present disclosure without creative efforts shall fall within the protection scope of the present disclosure.

### Embodiment 1

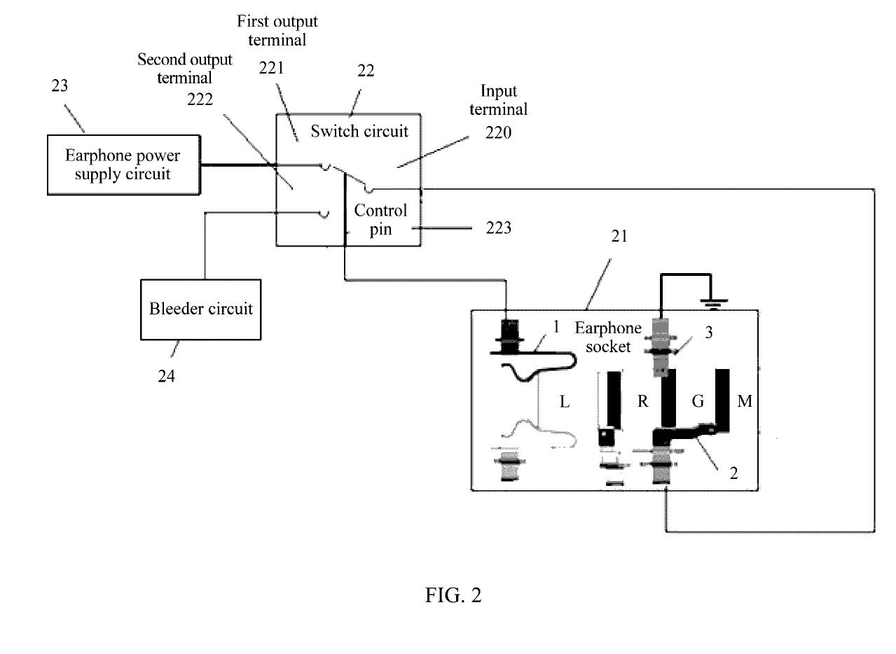

FIG. 2 is a schematic structural diagram (which shows only parts related to an earphone socket) of a terminal according to an embodiment of the present disclosure. As shown in FIG. 2, the terminal includes: an earphone socket 21, a switch circuit 22, an earphone power supply circuit 23, and a bleeder circuit 24. The earphone socket 21 includes a first pin 1 and a second pin 2, the switch circuit 22 includes a control pin 223, an input terminal 220, a first output terminal 221, and a second output terminal 222. The first pin 1 of the earphone socket 21 is connected to the control pin 223 of the switch circuit 22, the second pin 2 of the earphone socket 21 is connected to the input terminal 220 of the switch circuit 22, the first output terminal 221 of the switch circuit 22 is connected to the earphone power supply circuit 23, and the second output terminal 222 of the switch circuit 22 is connected to the bleeder circuit 24. The bleeder circuit is configured to reduce a difference between voltages passing through an audio-left channel or an audio-right channel of the earphone, the terminal determines, by detecting a voltage of the first pin, whether the earphone is plugged or unplugged, and the terminal supplies power to the earphone by using the second pin 2.

It should be noted that the terminal supplies power to or charges the earphone by using the earphone power supply circuit 23. For example, if the earphone is an ordinary earphone, the earphone power supply circuit 23 may be a circuit that supplies power to a microphone of the earphone; if the earphone is a noise reduction earphone, the earphone power supply circuit 23 may be a circuit that supplies power to or charges the earphone.

There are two earphone socket designs on the market. For the first earphone socket design, before the earphone is plugged into the earphone socket, the first pin 1 of the earphone socket 21 is not in contact with a section L, and after the earphone is plugged into the earphone socket, the first pin 1 of the earphone socket 21 is in contact with the section L. For the second earphone socket design, before the earphone is plugged into the earphone socket, the first pin 1 of the earphone socket 21 is in contact with the section L, and after the earphone is plugged into the earphone socket, the first pin 1 of the earphone socket 21 is not in contact with the section L, that is, the first pin 1 of the earphone socket 21 flicks off.

For the first type of earphone socket, when an input voltage of the control pin 223 of the switch circuit 22 is lower than a first preset voltage value (the input voltage of the control pin 223 of the switch circuit 22 is a low level), the input terminal 220 of the switch circuit 22 is connected to the first output terminal 221 of the switch circuit 22; or when an input voltage of the control pin 223 of the switch circuit 22 is higher than a second preset voltage value (the input voltage of the control pin 223 of the switch circuit 22 is a high level), the input terminal 220 of the switch circuit 22 is connected to the second output terminal 222 of the switch circuit 22.

For the second type of earphone socket, when an input voltage of the control pin 223 of the switch circuit 22 is higher than a first preset voltage value (the input voltage of the control pin 223 of the switch circuit 22 is a high level), the input terminal 220 of the switch circuit 22 is connected to the first output terminal 221 of the switch circuit 22; or when an input voltage of the control pin 223 of the switch circuit 22 is lower than a second preset voltage value (the input voltage of the control pin 223 of the switch circuit 22 is a low level), the input terminal 220 of the switch circuit 22 is connected to the second output terminal 222 of the switch circuit 22.

The first preset voltage value and the second preset voltage value are preset voltage values, and values of the first preset voltage value and the second preset voltage value may be set according to an actual requirement, which is not specifically limited in this embodiment of the present disclosure.

It should be noted that when the earphone is being plugged into or unplugged from the earphone socket, the voltage of the first pin 1 of the earphone socket 21 changes. Generally, when the first pin 1 of the earphone socket 21 is in contact with the earphone, the voltage of the first pin 1 of the earphone socket 21 is a low level, and the input voltage input to the control pin 223 of the switch circuit 22 is also a low level; when the first pin 1 of the earphone socket 21 is not in contact with the earphone, the voltage of the first pin 1 of the earphone socket 21 is a high level, and the input voltage of the control pin 223 of the switch circuit 22 is also a high level.

For the first type of earphone socket, when the earphone is being plugged into or unplugged from the earphone socket 21, if the first pin 1 of the earphone socket 21 is not connected to the section L of the earphone, the voltage of the first pin 1 is a high level, and the input terminal 220 of the switch circuit 22 is connected to the second output terminal 222 of the switch circuit 22, that is, the earphone power supply circuit 23 and the second pin 2 of the earphone socket 21 are disconnected. Therefore, a voltage on the earphone power supply circuit 23 does not form a loop on the audio-left channel or the audio-right channel of the earphone, and no noise comes from the audio-left channel or the audio-right channel of the earphone.

For the second type of earphone socket, when the earphone is being plugged into or unplugged from the earphone socket 21, if the first pin 1 of the earphone socket 21 does not flick off, the voltage of the first pin 1 is a low level, and the input terminal 220 of the switch circuit 22 is connected to the second output terminal 222 of the switch circuit 22, that is, the earphone power supply circuit 23 and the second pin 2 of the earphone socket 21 are disconnected. Therefore, a voltage on the earphone power supply circuit 23 does not form a loop on the audio-left channel or the audio-right channel of the earphone, and no noise comes from the audio-left channel or the audio-right channel of the earphone.

According to the terminal capable of reducing noise generated in a process of plugging or unplugging an earphone provided in this embodiment of the present disclosure, a switch circuit is added into the terminal, and when an input voltage of a control pin of the switch circuit is a high level or a low level (for an earphone type used with the terminal, either of a high level and a low level is selected), an input terminal of the switch circuit is connected to a second output terminal of the switch circuit, that is, a connection between an earphone power supply circuit and a second pin of an earphone socket is disconnected. Therefore, a voltage on the earphone power supply circuit does not form a loop on an audio-left channel or an audio-right channel of the earphone, and no noise comes from the audio-left channel or the audio-right channel of the earphone, so that noise generated when the earphone is being plugged into or unplugged from the earphone socket is effectively reduced.

When the earphone is being plugged into or unplugged from the earphone socket, the voltage of the first pin 1 of the earphone socket 21 changes. Generally, when the first pin 1 of the earphone socket 21 is in contact with the earphone, the voltage of the first pin 1 of the earphone socket 21 is a low level; when the first pin 1 of the earphone socket 21 is not in contact with the earphone, the voltage of the first pin 1 of the earphone socket 21 is a high level. However, on some occasions, the voltage of the first pin 1 does not change obviously; therefore, the switch circuit cannot accurately determine whether the first pin 1 of the earphone socket 21 is in contact with the earphone, which may cause incorrect use of the switch circuit 22. The following solution manners may be used for the foregoing problem.

Optionally, the problem that the switch circuit cannot accurately determine whether the first pin 1 of the earphone socket 21 is in contact with the earphone can be resolved in a software manner. The terminal further includes a CPU (not shown in the figure), where that the first pin of the earphone socket is connected to the control pin of the switch circuit is specifically: the CPU is electrically connected to the first pin 1 of the earphone socket 21, and electrically connected to the control pin of the switch circuit 22. The CPU is configured to: adjust the input voltage of the control pin of the switch circuit to be lower than the first preset voltage value according to the voltage of the first pin 1 of the earphone socket 21; or adjust the input voltage of the control pin of the switch circuit to be higher than the second preset voltage value according to the voltage of the first pin 1 of the earphone socket 21.

By electrically connecting the first pin 1 of the earphone socket 21 and the control pin 223 of the switch circuit 22 to the CPU separately, the CPU adjusts the input voltage of the control pin 223 of the switch circuit 22 to be lower than the first preset voltage value according to the voltage of the first pin 1 of the earphone socket 21; or adjusts the input voltage of the control pin 223 of the switch circuit 22 to be higher than the second preset voltage value according to the voltage of the first pin 1 of the earphone socket 21. That is, the CPU adjusts a voltage obtained from the first pin 1 of the earphone socket 21 to a voltage of a high level or a low level that can be accurately identified by the control pin 223 of the switch circuit 22. For a specific extent of adjustment, reference may be made to the first preset voltage value and the second preset voltage value. Therefore, there is no need to add hardware, and by controlling connection and disconnection between the earphone power supply circuit 23 and the second pin 2 of the earphone socket 21 in a software manner without increasing manufacturing costs of the terminal, noise generated when the earphone is being plugged into or unplugged from the earphone socket 21 can still be effectively reduced.

Optionally, the problem that the switch circuit cannot accurately determine whether the first pin 1 of the earphone socket 21 is in contact with the earphone can be resolved in a hardware manner. The terminal further includes a voltage adjustment unit (not shown in the figure), where that the first pin 1 of the earphone socket 21 is connected to the control pin 23 of the switch circuit 22 is specifically: the first pin 1 of the earphone socket 21 is connected to one terminal of the voltage adjustment unit, and another terminal of the voltage adjustment unit is connected to the control pin 223 of the switch circuit 22. The voltage adjustment unit is configured to: adjust the input voltage of the control pin 223 of the switch circuit 22 to be lower than the first preset voltage value according to the voltage of the first pin 1 of the earphone socket 21; or adjust the input voltage of the control pin 223 of the switch circuit 22 to be higher than the second preset voltage value according to the voltage of the first pin 1 of the earphone socket 211.

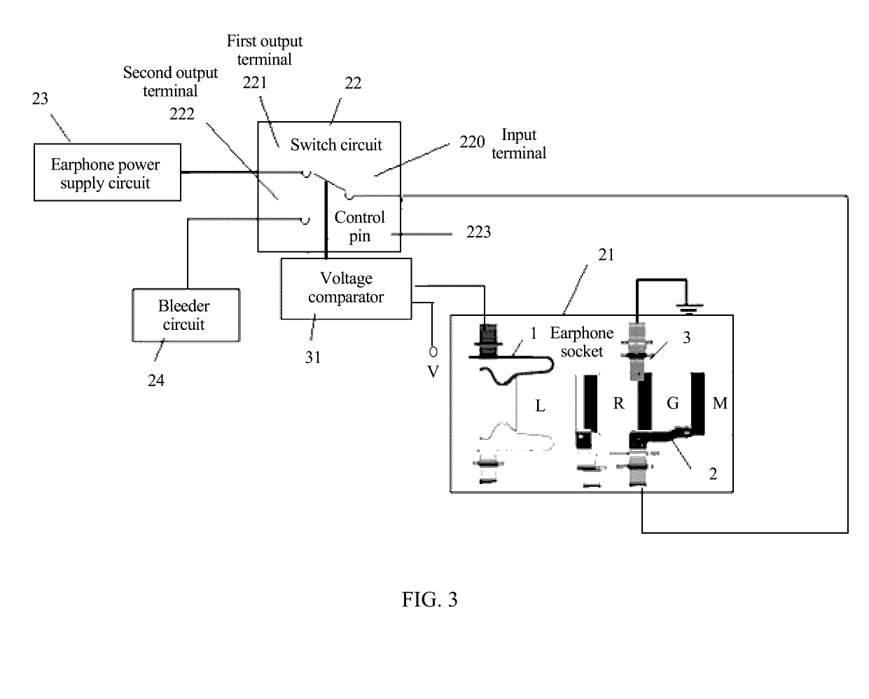

FIG. 3 is a schematic structural diagram (which shows only parts related to an earphone socket 21) of a terminal according to an embodiment of the present disclosure. This embodiment may be implemented based on the embodiment shown in FIG. 2. Only a part different from FIG. 2 is described herein, and for a same part, reference may be made to a description of FIG. 2.

Optionally, the voltage adjustment unit is specifically a voltage comparator 31, where that the first pin 1 of the earphone socket 21 is connected to the control pin 223 of the switch circuit 22 is specifically (as shown in FIG. 3): the first pin 1 of the earphone socket 21 is connected to a first terminal of the voltage comparator 31, a second terminal of the voltage comparator 31 is connected to a reference voltage V, and a third terminal of the voltage comparator 31 is connected to the control pin 223 of the switch circuit 22. The voltage comparator 31 is configured to: adjust the input voltage of the control pin 223 of the switch circuit 22 to be lower than the first preset voltage value according to the voltage of the first pin 1 of the earphone socket 21 and the reference voltage V; or adjust the input voltage of the control pin 223 of the switch circuit 22 to be higher than the second preset voltage value according to the voltage of the first pin 1 of the earphone socket 21 and the reference voltage V. The voltage comparator 31 compares a voltage obtained from the first pin 1 of the earphone socket 21 with the reference voltage V, and adjusts a voltage that is to be output by the voltage comparator 31 to a voltage of a high level or a low level that can be accurately identified by the control pin 223 of the switch circuit 22. For a specific extent of adjustment, reference may be made to the first preset voltage value and the second preset voltage value.

By using the voltage comparator 31 to adjust an output voltage of the pin 1 of the earphone socket 21, the control pin 223 of the switch circuit 22 can quickly and accurately identify a high level or a low level, so as to more accurately control connection and disconnection between the earphone power supply circuit 23 and the second pin 2 of the earphone socket 21, that is, can more accurately control a status of the switch circuit 22, thereby effectively reducing noise generated when the earphone is being plugged into or unplugged from the earphone socket 21.

The voltage comparator is relatively common in some approaches, and a working principle of the voltage comparator is not described in detail herein.

It should be noted that there may be multiple specific structures for the bleeder circuit. The following uses an example to describe a specific structure of the bleeder circuit. Which structure is used in an actual manufacturing process of the terminal may be set according to an actual requirement, which is not specifically limited in this embodiment of the present disclosure.

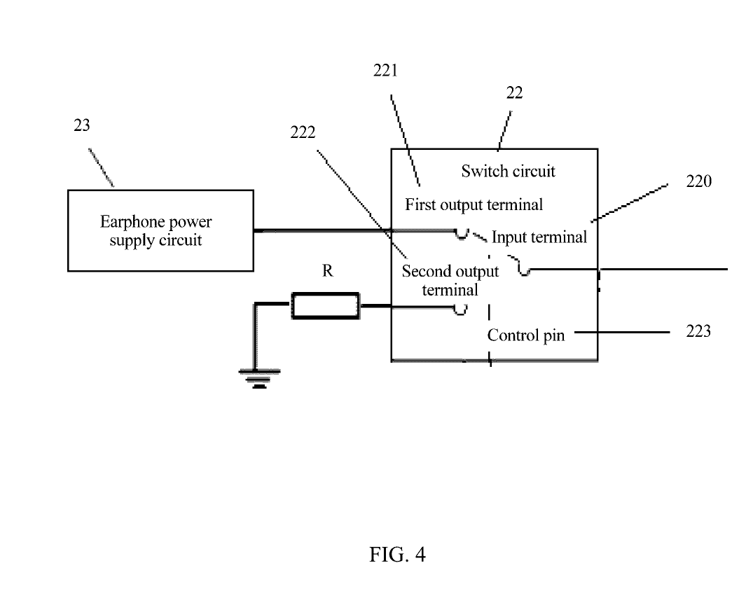

As shown in FIG. 4, the bleeder circuit 24 includes a pull-down resistor R, where one terminal of the pull-down resistor R is connected to the second output terminal 222 of the switch circuit 22, and the other terminal of the pull-down resistor R is connected to a ground of the terminal.

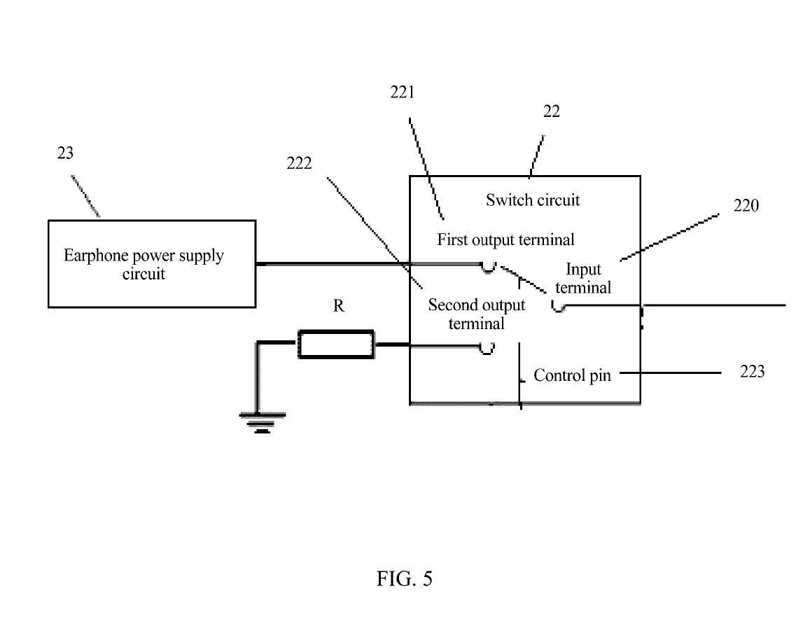

As shown in FIG. 5, the bleeder circuit 24 includes a pull-down resistor R, where one terminal of the pull-down resistor R is connected to the second output terminal 222 of the switch circuit 22, and the other terminal of the pull-down resistor R is connected to the earphone power supply circuit 23.

The bleeder circuit is configured to reduce the difference between the voltages passing through the audio-left channel or the audio-right channel of the earphone.

Preferably, when the other terminal of the pull-down resistor R is connected to the ground of the terminal, a resistance of the pull-down resistor R is less than or equal to 1 kΩ; or when the other terminal of the pull-down resistor R is connected to the earphone power supply circuit, a resistance of the pull-down resistor R is greater than or equal to 5 kΩ. In this case, the difference between the voltages passing through the audio-left channel or the audio-right channel of the earphone approximates to zero.

According to the terminal provided in this embodiment of the present disclosure, a switch circuit is added into the terminal, and when an input voltage of a control pin 223 of the switch circuit is a high level or a low level (for an earphone type used with the terminal, either of a high level and a low level is selected), an input terminal 220 of the switch circuit is connected to a second output terminal 222 of the switch circuit, that is, a connection between an earphone power supply circuit 23 and a second pin 2 of an earphone socket 21 is disconnected. Therefore, a voltage on the earphone power supply circuit does not form a loop on an audio-left channel or an audio-right channel of the earphone, and no noise comes from the audio-left channel or the audio-right channel of the earphone, so that noise generated when the earphone is being plugged into or unplugged from the earphone socket 21 is effectively reduced.

### Embodiment 2

This embodiment of the present disclosure makes an improvement of a terminal on the basis of Embodiment 1, to further reduce noise generated in a process of plugging or unplugging an earphone.

When the earphone is being plugged into or unplugged from an earphone socket 21 to a position shown in FIG. 3, if a first pin 1 of the earphone socket 21 is connected to a section L of the earphone, a voltage of the first pin 1 is a low level, and an input terminal 220 of the switch circuit 22 is connected to a first output terminal 221 of the switch circuit 22, that is, an earphone power supply circuit 23 is connected to a second pin 2 of the earphone socket 21. In this case, if a pin 3 of the earphone socket 21 is connected to a section R of the earphone, and the second pin 2 of the earphone socket 21 is connected to a section G of the earphone, a voltage on the earphone power supply circuit 23 forms a loop on an audio-right channel of the earphone, and then noise comes from the audio-right channel of the earphone. For this case, a length of the second pin 2 of the earphone socket needs to be redesigned. In specific implementation, a contact of the second pin 2 of the earphone socket 21 may be moved X mm in an unplugging direction of the earphone, so that the contact of the second pin 2 of the earphone socket 21 is not in contact with the section G of the earphone at a moment when the first pin 1 of the earphone socket 21 comes into contact with the section L of the earphone. In this way, the voltage on the earphone power supply circuit 23 does not form a loop on the audio-right channel of the earphone, and no noise comes from the audio-right channel of the earphone. Therefore, the noise generated in the process of plugging or unplugging the earphone can be eliminated.

In designing the earphone socket, the following conditions need to be satisfied: After the earphone is entirely plugged into the earphone socket, the contact of the second pin of the earphone socket comes into reliable contact with the earphone; and when the earphone is being plugged into the earphone socket, the contact of the second pin of the earphone socket is not in contact with a conductive section of the earphone at a moment when the first pin of the earphone socket comes into contact with the earphone. In this case, when the first pin 1 of the earphone socket 21 is connected to the section L of the earphone, and the earphone power supply circuit 23 is connected to the second pin 2, the second pin 2 of the earphone socket 21 is not connected to the section G of the earphone. In this way, the voltage on the earphone power supply circuit 23 does not form a loop on the audio-right channel of the earphone, and no noise comes from the audio-right channel of the earphone. Therefore, the noise generated in the process of plugging or unplugging the earphone can be eliminated.

For example, in designing the earphone socket 21, the following conditions need to be satisfied: (1) After the earphone is entirely plugged into the earphone socket 21, the contact of the second pin 2 of the earphone socket 21 can come into reliable contact with a section M of the earphone; and (2) when the earphone is being plugged into the earphone socket 21, the contact of the second pin 2 of the earphone socket 21 is not in contact with the section G of the earphone at a moment when the first pin 1 of the earphone socket 21 comes into contact with the section L of the earphone.

It should be noted that a specific value of X needs to be set according to the two conditions that need to be satisfied in designing the earphone, which is not specifically limited in this embodiment of the present disclosure.

### Embodiment 3

FIG. 6 is a structural diagram of a system according to an embodiment of the present disclosure. As shown in FIG. 6, the system includes the terminal and the earphone in the foregoing Embodiment 1.

It should be noted that, in addition to eliminating, in a manner of setting the second pin 2 of the earphone socket 21 mentioned in Embodiment 2, noise generated when the earphone is being plugged into or unplugged from the earphone socket, noise generated in a process of plugging or unplugging the earphone can also be eliminated by reducing a section (a corresponding section of a standard earphone) on an earphone side by X mm. In designing the earphone, the following conditions need to be satisfied: After the earphone is entirely plugged into the earphone socket, a contact of a second pin of the earphone socket comes into reliable contact with the earphone; and when the earphone is being plugged into the earphone socket, the contact of the second pin of the earphone socket is not in contact with a conductive section of the earphone at a moment when a first pin of the earphone socket comes into contact with the earphone.

For example, in designing the earphone, the following conditions need to be satisfied: (1) After the earphone is entirely plugged into the earphone socket 21, the contact of the second pin 2 of the earphone socket 21 comes into reliable contact with a section M of the earphone; and (2) when the earphone is being plugged into the earphone socket 21, the contact of the second pin 2 of the earphone socket 21 is not in contact with a section G of the earphone at a moment when a first pin 1 of the earphone socket 21 comes into contact with a section L of the earphone.

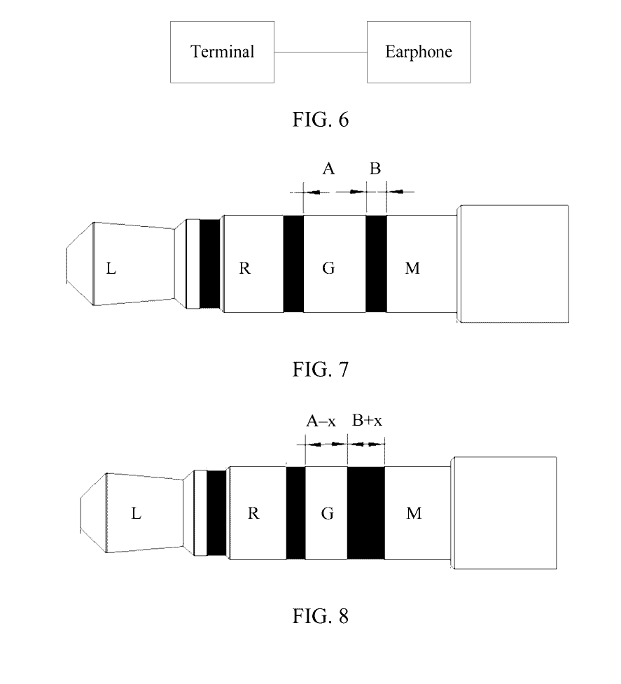

FIG. 7 is a schematic structural diagram of a standard earphone in some approaches. As shown in FIG. 8, when a line order of the standard earphone is L, R, G, and M from left to right, a length of the section G of the standard earphone is A mm, and a length of an insulation layer between the section G and the section M is B mm.

FIG. 8 is a schematic structural diagram of an improved earphone according to an embodiment of the present disclosure. FIG. 8 shows a modification to the standard earphone on the basis of FIG. 7, that is, a length of the section G of the improved earphone is reduced by X mm compared with that of the section G of the standard earphone. As shown in FIG. 8, the length of the section G of the improved earphone is W=(A−X) mm, and the length of the insulation layer between the section G and the section M is (B+X) mm.

Likewise, when the line order of the earphone is L, R, M, and G, a length of the section M of the earphone is set to V mm, that is, the length of the section M of the improved earphone is V=(A−X) mm, and the length of the insulation layer between the section M and the section G is (B+X) mm.

It should be noted that a specific value of X needs to be set according to the two conditions that need to be satisfied in designing the earphone, which is not specifically limited in this embodiment of the present disclosure.

According to the system provided in this embodiment, a switch circuit is added into a terminal, and a length of a section of an earphone is shortened, so that a voltage on an earphone power supply circuit 23 does not form a loop on an audio-left channel or an audio-right channel of the earphone, and no noise comes from the audio-left channel or the audio-right channel of the earphone. Therefore, noise generated when the earphone is being plugged into or unplugged from an earphone socket 21 is eliminated.

It may be clearly understood by persons skilled in the art that, for a purpose of convenient and brief description, only the foregoing functional module division is used as an example for description. In actual application, the foregoing functions are assigned to different functional modules for implementation as required, that is, an inner structure of the apparatus is divided into different functional modules to implement all or some of the functions described above. For a detailed working process of the foregoing apparatus, reference may be made to a corresponding process in the foregoing method embodiments, and details are not described herein again.

Finally, it should be noted that the foregoing embodiments are merely intended to describe the technical solutions of the present disclosure, but not to limit the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

1. A terminal comprising:
an earphone socket comprising a first pin and a second pin;
a switch comprising an input terminal coupled to the second pin, a first output terminal, a second output terminal, and a control pin coupled to the first pin and configured to cause the input terminal to couple to the first output terminal when an input control pin voltage of the control pin is lower than a first preset voltage value;
an earphone power supply coupled to the first output terminal; and
a bleeder coupled to the second output terminal and configured to reduce a difference between voltages passing through an audio-left channel or an audio-right channel of an earphone,
wherein the terminal is configured to:
determine, by detecting a first pin voltage of the first pin, whether the earphone is plugged or unplugged; and
supply power to the earphone using the second pin.

2. The terminal of claim 1, further comprising a voltage adjuster, wherein the voltage adjuster comprises a first terminal coupled to the first pin and a second terminal coupled to the control pin, and wherein the voltage adjuster is configured to:
adjust the input control pin voltage to be lower than the first preset voltage value according to the first pin voltage; or
adjust the input control pin voltage to be higher than the second preset voltage value according to the first pin voltage.

3. The terminal of claim 2, wherein the voltage adjuster comprises a voltage comparator is configured to:
adjust the input control voltage to be lower than the first preset voltage value according to the first pin voltage; or
adjust the input control pin voltage to be higher than the second preset voltage value according to the first pin voltage.

4. The terminal of claim 1, further comprising a central processing unit (CPU) electrically coupled to the first pin of the earphone socket and the control pin and configured to:
adjust the input control pin voltage to be lower than the first preset voltage value according to the first pin voltage; or
adjust the input control pin voltage to be higher than the second preset voltage value according to the first pin voltage.

5. The terminal claim 1, further comprising a ground, wherein the bleeder comprises a pull-down resistor, wherein the pull-down resistor comprises a first terminal and a second terminal, wherein the first terminal is coupled to the second output terminal, and wherein the second terminal coupled to the ground or the earphone power supply.

6. The terminal of claim 5, wherein a resistance of the pull-down resistor is less than or equal to 1 kiloohm (kΩ) when the second terminal is coupled to the ground.

7. The terminal of claim 5, wherein a resistance of the pull-down resistor is greater than or equal to 5 kiloohms (kΩ) when the second terminal is coupled to the earphone power supply.

8. The terminal of claim 1, wherein the second pin comprises a contact configured to:
come into reliable contact with the earphone after the earphone is entirely plugged into the earphone socket; and
not contact a conductive section of the earphone when the earphone is being plugged into the earphone socket and when the first pin contacts the earphone.

9. A terminal comprising:
an earphone socket comprising a first pin and a second pin;
a switch comprising an input terminal coupled to the second pin, a first output terminal, a second output terminal, and a control pin coupled to the first pin and configured to cause the input terminal to couple to the first output terminal when an input control pin voltage of the control pin is higher than a first preset voltage value;
an earphone power supply coupled to the first output terminal; and
a bleeder coupled to the second output terminal and configured to reduce a difference between voltages passing through an audio-left channel or an audio-right channel of the earphone,
wherein the terminal is configured to:
determine, by detecting a first pin voltage of the first pin, whether the earphone is plugged or unplugged; and
supply power to the earphone using the second pin.

10. The terminal of claim 9, further comprising a voltage adjuster, wherein the voltage adjuster comprises a first terminal coupled to the first pin and a second terminal coupled to the control pin, and wherein the voltage adjuster is configured to:
adjust the input control pin voltage to be lower than the first preset voltage value according to the first pin voltage; or
adjust the input control pin voltage to be higher than the second preset voltage value according to the first pin voltage.

11. The terminal of claim 10, wherein the voltage adjuster is a voltage comparator configured to:
adjust the input control pin voltage to be lower than the first preset voltage value according to the first pin voltage; or
adjust the input control pin voltage to be higher than the second preset voltage value according to the first pin voltage.

12. The terminal of claim 9, further comprising a central processing unit (CPU) electrically coupled to the first pin of the earphone socket and the control pin and configured to:
adjust the input control pin voltage to be lower than the first preset voltage value according to the first pin voltage; or
adjust the input control pin voltage to be higher than the second preset voltage value according to the first pin voltage.

13. The terminal of claim 9, further comprising a ground, wherein the bleeder comprises a pull-down resistor, wherein the pull-down resistor comprises a first terminal and a second terminal, wherein the first terminal is coupled to the second output terminal, and the other and wherein the second terminal is coupled to the ground or the earphone power supply.

14. The terminal of claim 13, wherein a resistance of the pull-down resistor is less than or equal to 1 kiloohm (kΩ) when the second terminal is coupled to the ground.

15. The terminal of claim 13, wherein a resistance of the pull-down resistor is greater than or equal to 5 kiloohms (kΩ) when the second terminal is coupled to the earphone power supply.

16. The terminal of claim 9, wherein the second pin comprises a contact configured to:
come into reliable contact with the earphone after the earphone is entirely plugged into the earphone socket; and
not contact a conductive section of the earphone when the earphone is being plugged into the earphone socket and when the first pin contacts the earphone.

17. A system comprising:
a terminal comprising:
an earphone socket comprising a first pin and a second pin;
a switch comprising an input terminal coupled to the second pin, a first output terminal, a second output terminal, and a control pin coupled to the first pin and configured to:
cause the input terminal to couple to the first output terminal when an input control pin voltage of the control pin is lower than a first preset voltage value; and
cause the input terminal to couple to the second output terminal when the input control pin voltage is higher than a second preset voltage value;
an earphone power supply coupled to the first output terminal; and
a bleeder coupled to the second output terminal and configured to reduce a difference between voltages passing through an audio-left channel or an audio-right channel of an earphone,
wherein the terminal is configured to:
determine, by detecting a first pin voltage of the first pin, whether the earphone is plugged or unplugged; and
supply power to the earphone using the second pin; or
the terminal comprising:
the earphone socket comprising the first pin and the second pin;
the switch comprising the input terminal coupled to the second pin, the first output terminal, the second output terminal, and the control pin coupled to the first pin and configured to:
cause the input terminal to couple to the first output terminal when an input control pin voltage of the control pin is higher than a first preset voltage value; and
cause the input terminal to couple to the second output terminal when the input control pin voltage is lower than a second preset voltage value;
an earphone power supply coupled to the first output terminal; and
a bleeder coupled to the second output terminal and confirmed to reduce a difference between voltages passing through an audio left channel or an audio-right channel of the earphone,
wherein the terminal is configured to:
determine, by detecting a first pin voltage of the first pin, whether the earphone is plugged or unplugged, and
supply power to the earphone using the second pin.

18. The system of claim 17, wherein the second pin comprises a contact configured to:
come into reliable contact with the earphone after the earphone is entirely plugged into the earphone socket; and
not contact a conductive section of the earphone when the earphone is being plugged into the earphone socket and when the first pin contacts the earphone.

19. The terminal of claim 1, wherein the control pin is further configured to cause the input terminal to couple to the second output terminal when the input control pin voltage is higher than a second preset voltage value.

20. The terminal of claim 9, wherein the control pin is further configured to cause the input terminal to couple to the second output terminal when the input control pin voltage is lower than a second preset voltage value.
